(19) United States
(12) Patent Application Publication
(10) Pub. No.: US 2016/0369447 A1
(43) Pub. Date: Dec. 22, 2016

(54) WASHING MACHINE WITH A DISCOLORATION RESERVOIR AND METHOD FOR WASHING TEXTILES IN SUCH A WASHING MACHINE

(71) Applicant: Henkel AG & Co. KGaA, Duesseldorf (DE)

(72) Inventors: Iwona Spill, Berlin (DE); Peter Schmiedel, Duesseldorf (DE); Christian Kropf, Hilden (DE); Hendrik Hellmuth, Darmstadt (DE); Bent Rogge, Duesseldorf (DE)

(73) Assignee: Henkel AG & Co. KGaA, Duesseldorf (DE)

(21) Appl. No.: 15/257,699

(22) Filed: Sep. 6, 2016

Related U.S. Application Data
(63) Continuation of application No. PCT/EP2015/056576, filed on Mar. 26, 2015.

(30) Foreign Application Priority Data
Mar. 31, 2014 (DE) 10 2014 206 097.4

(51) Int. Cl. D06F 39/00; C02F 1/32; D06F 39/10; D06F 39/04; D06F 35/00; D06F 39/08

(52) U.S. Cl. CPC D06F 39/006; D06F 35/006; D06F 39/083; D06F 39/10; D06F 39/045; C02F 1/32; C02F 2201/3222; C02F 2101/308

(57) ABSTRACT

The invention relates to a washing machine (1) with a washing chamber (2) for receiving a washing liquid and textiles to be cleaned and with a discoloration reservoir (3) which has an inlet (4) for introducing washing liquid from the washing chamber (2) into the discoloration reservoir (3) and an outlet (5) for discharging washing liquid from the discoloration reservoir (3) into the washing chamber (2), and which moreover has at least one activation module, such as, for example, a UV radiation source or an electrode arrangement which is suitable for initiating, within the discoloration reservoir (3), a process for forming free radicals in the washing liquid. Furthermore, a method for washing textiles in such a washing machine is also specified.

### FIELD OF THE INVENTION

The present invention generally relates to a washing machine comprising a decoloration reservoir and to a method for washing textiles in such a washing machine.

### BACKGROUND OF THE INVENTION

It is known that colored textiles may fade during washing. Depending on the washing temperature, the selected washing program and the washing agent used, individual dyes or several dyes may wash out of the textiles to different extents. The dyes released are transferred into the washing fluid, generally washing liquor, and in this way come into contact with other textiles, to which the dyes may be transferred. This leads to undesired discoloration of light textiles in particular, and in the worst case may completely ruin a piece of clothing, for example.

Nowadays, many different dyes are used in the textile industry. These dyes vary greatly in terms of their chemical structure, their properties and their binding to a textile. Therefore, distinctions can be drawn between direct dyes, reactive dyes, disperse dyes, acid dyes, vat dyes and others, for example. Various types of fabric, such as cotton, polyamide or polyester, require different types of dye in order to be dyed efficiently and in a long-lasting manner. This wide range of dyes used in the textile industry presents a great challenge when seeking efficient measures to counteract discoloration.

In order to inhibit the fading process, various efforts have already been made in the field of washing-agent compositions in particular. Nowadays, washing agents for colors are thus usually mixed with dye transfer inhibitors, which are intended to prevent dyes from being transferred to other textiles. One drawback of these additives is that they are usually only effective against a single dye or a few dyes, and not against a broad spectrum of dyes. Commercial dye transfer inhibitors are particularly effective against red direct dye, but have little to no effect on disperse dyes, acid dyes or vat dyes. However, precisely this kind of broad color spectrum is found in normal domestic colored washes, since, for reasons of efficiency, laundry is generally only roughly (light/dark) sorted by color, at best, and as a general rule not by individual hues. In order to achieve corresponding effectiveness for a mixture of dyes of this type, it would be necessary to incorporate many different dye transfer inhibitors into the washing-agent compositions. This would, however, increase the complexity of washing-agent formulas and also the costs of the washing agent in an undesired manner.

U.S. Pat. No. 3,927,967 discloses a method for treating stains on textiles, in which the textiles are subjected to a treatment using a washing-agent solution, a photoactivator and oxygen, and are irradiated with visible light during this treatment process. However, a method of this type cannot be used to treat dyed textiles, in particular for inhibiting the fading process, since the treatment acts not only on dyes dissolved in the washing fluid, but also on the dyes bound to the textiles, and as a result the textiles bleach and lose color in an undesired manner.

WO 2009/067838 A2 describes a method for cleaning laundry using electrolyzed water by means of oxidative radicals. For this purpose, a water tank is provided in addition to the washing machine. The water contained in the tank is electrolyzed by an electrolysis unit, as a result of which the water contains oxidative radicals, which are highly reactive and therefore have a cleaning and disinfecting effect. The water prepared in this way is then made available for the actual washing process. This is disadvantageous in that the textiles to be washed come into contact with the electrolyzed water during the washing process. As a result, said water acts not only on soiling on the textiles but also on the dyes bound to the textiles, and this may lead to undesired bleaching of the colors.

The problem addressed by the present invention is therefore to provide simple and cost-effective measures which minimize the risk of discoloration during the washing process in a washing machine while simultaneously treating the textiles to be washed with care.

This problem is solved by a washing machine disclosed herein as well as other advantageous embodiments and developments.

Furthermore, other desirable features and characteristics of the present invention will become apparent from the subsequent detailed description of the invention and the appended claims, taken in conjunction with the accompanying drawings and this

### BACKGROUND OF THE INVENTION

### BRIEF SUMMARY OF THE INVENTION

A washing machine (1) comprising a washing chamber (2) for receiving a washing fluid and textiles to be cleaned, and comprising a decoloration reservoir (3), which has an inlet (4) for conveying washing fluid out of the washing chamber (2) into the decoloration reservoir (3) and has an outlet (5) for conveying washing fluid out of the decoloration reservoir (3) into the washing chamber (2), which reservoir further comprises at least one activation module, which is suitable for initiating a process for forming free radicals in the washing fluid within the decoloration reservoir (3).

### BRIEF DESCRIPTION OF THE DRAWINGS

The present invention will hereinafter be described in conjunction with the following drawing figures, wherein like numerals denote like elements, and

FIG. 1 is a schematic view of an embodiment of the decoloration reservoir according to the invention;

FIG. 2 is a schematic view of an alternative embodiment of the decoloration reservoir according to the invention;

FIG. 3 is a schematic view of a washing machine comprising the decoloration reservoir from FIG. 1 according to the invention; and

FIG. 4 is a schematic view of a washing machine comprising the decoloration reservoir from FIG. 2 according to the invention.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The present invention relates to a washing machine comprising a washing chamber for receiving a washing fluid and textiles to be cleaned, and comprising a decoloration reservoir, which has an inlet for conveying washing fluid out of the washing chamber into the decoloration reservoir and has an outlet for conveying washing fluid out of the decoloration reservoir into the washing chamber, which reservoir further comprises at least one activation module, which is suitable for initiating a process for forming free radicals in the washing fluid within the decoloration reservoir.

Within the meaning of the invention, the washing machine may in principle be a common domestic, cuboid washing machine having a capacity of approximately 4 to 9 kg of laundry. However, other types of washing machine, for example industrial washing machines having different constructions and considerably greater capacities, are also covered by the invention. The washing chamber is the space through which washing fluid flows during a washing cycle. In a common domestic washing machine, this is generally a washing drum and the space immediately surrounding said drum.

It has been shown that the dyes transferred into the washing fluid during a washing cycle can be decomposed by free radicals. Free radicals have at least one unpaired electron and for this reason are extremely reactive and therefore have a short life (generally <1 sec). They are able to react with the dyes dissolved in the washing fluid and to thus decompose said dyes. By way of example, the decomposition of the dye Acid Orange 7 is mentioned, which is decomposed by interaction with free radicals into colorless aromatic by-products, which are themselves converted into aliphatic acids by oxidation.

The washing machine according to the invention makes use of this interactive behavior between free radicals and dyes. For this purpose, it comprises the decoloration reservoir, into which the washing fluid containing dissolved dyes can be conveyed from the washing chamber. The activation module is arranged in the decoloration reservoir and is suitable for initiating a process for forming free radicals in the washing fluid within the decoloration reservoir. The free radicals formed act on and decompose the dyes in the washing fluid. The washing fluid treated in this way is then conveyed again out of the decoloration reservoir and into the washing chamber, and is made available for the rest of the washing process in the washing machine. The proportion of dissolved dyes in the entirety of the washing fluid found in the washing chamber is therefore significantly reduced, and as a result the risk of textile discoloration is minimized.

The outstanding action of the free radicals on a wide range of dyes has proven to be particularly advantageous. As a result, washing-agent additives that are each only effective against individual dyes can be largely dispensed with, and the textiles to be washed do not need to be carefully sorted into different colors before washing.

The washing machine according to the invention is advantageous in that solely the treatment of the washing fluid takes place within the decoloration reservoir, and an undesired impact of the reactive free radicals on the textiles in the washing chamber, generally in a washing drum, and on the dyes bound thereto is not possible or is largely eliminated. For this purpose, both the inlet for conveying the washing fluid out of the washing chamber into the decoloration reservoir and the outlet for conveying the washing fluid into the washing chamber are designed such that textiles cannot get into the decoloration reservoir. To do this, the inlet and/or the outlet of the decoloration reservoir can be equipped with suitable filters or gratings, for example, through which textiles cannot pass, but washing fluid can. In addition, the dimensions, in particular the cross-sectional area, of the inlet and/or the outlet can be such that it is not possible for textiles to enter the decoloration reservoir.

The length of the inlet and in particular of the outlet of the decoloration unit is such that, taking into account the average flow speed of the washing fluid through the decoloration reservoir and the average life of the free radicals, it can be assumed that the treated washing fluid contains practically no free radicals when leaving the decoloration reservoir.

The washing fluid is generally a washing liquor, in which washing agent is dissolved in water. Depending on requirements, other components can also be mixed into this washing liquor. In certain cases, pure water or other suitable fluids may also be used.

In a preferred embodiment of the invention, the activation module comprises a UV radiation source, i.e. the process for forming free radicals in the decoloration reservoir is initiated by UV radiation. In this variant, a washing liquor containing additional chemical components such as hydrogen peroxide (H₂O2) or titanium dioxide (TiO2) is used as the washing fluid. By means of the UV radiation emitted by the radiation source in the decoloration reservoir, the hydrogen peroxide or titanium dioxide contained in the washing liquor is activated and highly reactive hydroxyl radicals (OH radicals), which are capable of decomposing the dyes in the washing liquor, are produced as short-life products of these reactions. In addition to said hydrogen peroxide and titanium dioxide, many other chemical additives which can be activated by UV radiation to form free radicals are of course also suitable. The use of hydrogen peroxide lends itself particularly well, since it is already contained in many washing-detergent compositions as a bleaching agent.

The concentration of hydrogen peroxide in the washing fluid is preferably 0.1 to 50 mmol/l, particularly preferably 1 to 20 mmol/l.

Owing to the isolated treatment of the washing liquor in the decoloration reservoir, which is only accessible to the washing liquor and not to textiles, and owing to the short life of the free radicals, it is not possible for the UV radiation and/or the free radicals to have a direct impact on the textiles and to damage them in any way, for example to discolor them.

A quartz lamp or a UV LED may be used as a UV radiation source. However, other UV radiation sources such as gas discharge lamps, fluorescent lamps or lasers are also conceivable.

If a UV radiation source is present as an activation module, it is generally preferred for this source to be arranged in the decoloration reservoir and/or the decoloration reservoir to be designed such that the washing chamber does not receive any direct UV radiation, and more preferably no UV radiation at all, so that dyes in the textiles that may be present in the washing chamber are not damaged. This may e.g. be provided by there being a screen or a bend at the inlet and outlet in the direction of the washing chamber, and the washing fluid has to flow around the screen or the bend. For example, the inlets and outlets of the decoloration reservoir may be arranged in one direction so that they do not point in the direction of the washing chamber.

The preferred wavelength range of the emitted UV radiation is between 100 and 400 nm, particularly preferably between 250 and 400 nm. Initial tests have shown that there is a dependence between the wavelength of the emitted radiation and the type of decomposable dye.

In an alternative embodiment of the invention, the activation module comprises an electrode assembly, including an anode and a cathode. It is assumed that the chemical processes take place as follows: in this case, the free radicals form in the washing fluid by means of an electrochemical process. To do this, the anode and cathode can be installed in the decoloration reservoir and can each be connected to the positive and negative pole of a DC voltage source, respectively. The working hypothesis is that, during the electrolysis that is then to be implemented, the water contained in the washing fluid is split, forming OH radicals. The hydroxyl radicals produced in this way are capable of oxidizing the dyes dissolved in the washing fluid and rendering them harmless.

Particularly preferably, a boron-doped diamond electrode is used as the anode. This is generally a main body made of plastics material, metal or a semiconductor, for example silicon, which is coated with a thin, polycrystalline diamond layer. In order to achieve sufficient conductivity for the electrolysis, the diamond layer is doped with boron during production.

The effective surface area of the anode is preferably between 1 and 500 cm², preferably between 2 and 100 cm². The electrolysis is carried out at currents in the range of from 0.01 to 30 A, preferably 0.1 to 10 A.

The two above-mentioned variants, which have a UV radiation source and an electrode assembly as activation module, respectively, each separately provide good results for reducing dyes in the washing fluid. Nevertheless, according to the invention it is also possible to combine the two variants in order to achieve even better decoloration of the washing fluid. Here, for example, both the UV radiation source and the electrode assembly may be arranged in a common decoloration reservoir. Alternatively, a series or parallel connection of two decoloration reservoirs that each comprise an activation module is conceivable.

According to another embodiment of the washing machine according to the invention, at least one pump is provided which pumps the washing fluid from the washing chamber into the decoloration reservoir and/or out of said reservoir. This means that the decoloration process can be made more efficient.

The start, intensity and duration of the process for forming free radicals in the decoloration reservoir can preferably be controlled. Therefore, the start of the process can be linked to certain operating parameters being achieved, for example linked to a particular temperature of the washing fluid or to a certain phase of the washing cycle. For temperature-dependent control, a temperature sensor may for example be provided, by means of which the temperature of the washing fluid can be detected. In addition, purely time-based control may be provided, in which the process starts at a presettable time. The duration of the process can likewise be set such that said process stops once the quantity of dyes within the washing fluid falls below a certain level. In washing cycles at particularly low temperatures, in which there is no risk of dyes washing out into the washing fluid, the process can also be prevented from starting altogether. At high washing temperatures and when washing particularly non-colorfast textiles, however, the intensity and duration of the process can be accordingly increased.

The temperature of the washing liquid at which the washing machine according to the invention can be operated may be between 10 and 100° C., preferably between 20 and 60° C.

According to an embodiment of the invention, the decoloration reservoir may be permanently installed in a housing of the washing machine. Here, the power supply for the activation module and optionally for the pump may be coupled to the power supply of the washing machine. The decoloration reservoir may for example be attached below the drum or to the inside of the door of the washing machine. In order to convey the washing fluid into the decoloration reservoir and out of said reservoir again, appropriate lines can be provided in the washing machine which can be connected to the inlet and outlet of the decoloration reservoir. Therefore, the washing chamber may for example have a washing-fluid outlet, which can be connected to the inlet of the decoloration reservoir. Accordingly, the outlet of the decoloration reservoir can be connected to a washing-fluid inlet of the washing chamber so that the treated washing fluid can be guided out of the decoloration reservoir and back into the washing chamber.

Alternatively, the decoloration reservoir may be designed as a separate, preferably battery-operated, module. Said module may be attached to the inside of the door of the washing machine by means of an appropriate bracket, for example. The advantage of a module that can be separately installed is that it can only be inserted when required and is thus subjected to a lower level of wear. In addition, a separate module can also be retrofitted to an existing washing machine, or can be removed from a defective washing machine and installed in a new washing machine.

The invention thus also discloses a module that can be inserted into a washing machine, which module comprises a decoloration reservoir having an inlet for conveying washing fluid into the decoloration reservoir and an outlet for conveying washing fluid out of the decoloration reservoir, and which comprises at least one activation module, which is suitable for initiating a process for forming free radicals in the washing fluid within the decoloration reservoir.

A method for washing textiles in a washing machine using a washing machine is disclosed and comprises the steps of:
placing the textiles to be washed into the washing chamber of the washing machine;
starting a washing cycle;
conveying washing fluid from the washing chamber into the decoloration reservoir;
initiating a process for forming free radicals in the washing fluid in the decoloration reservoir;
decomposing dyes contained in the washing fluid by means of the free radicals;
conveying treated washing fluid out of the decoloration reservoir into the washing chamber.

In the following, the invention is explained in greater detail on the basis of embodiments with reference to the accompanying drawings, in which:

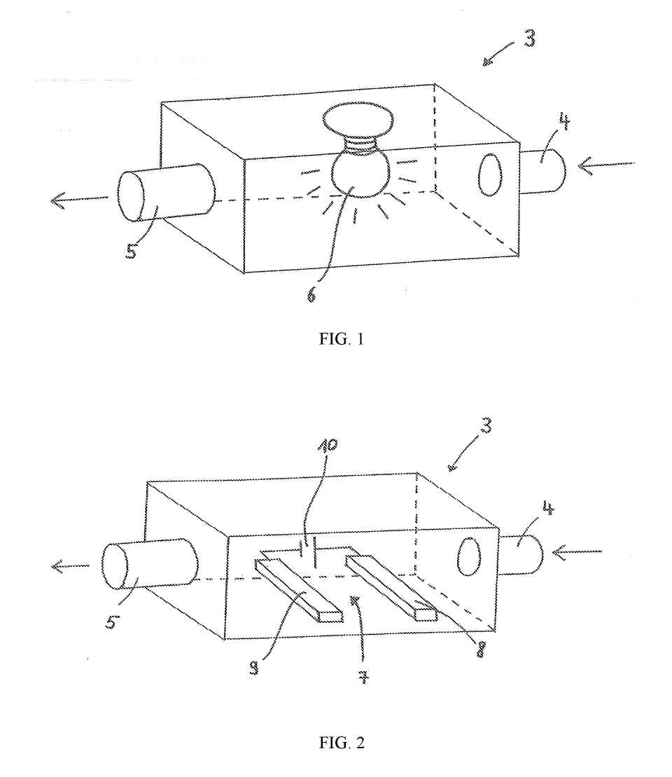

FIG. 1 is a schematic view of an embodiment of the decoloration reservoir according to the invention;

FIG. 2 is a schematic view of an alternative embodiment of the decoloration reservoir according to the invention;

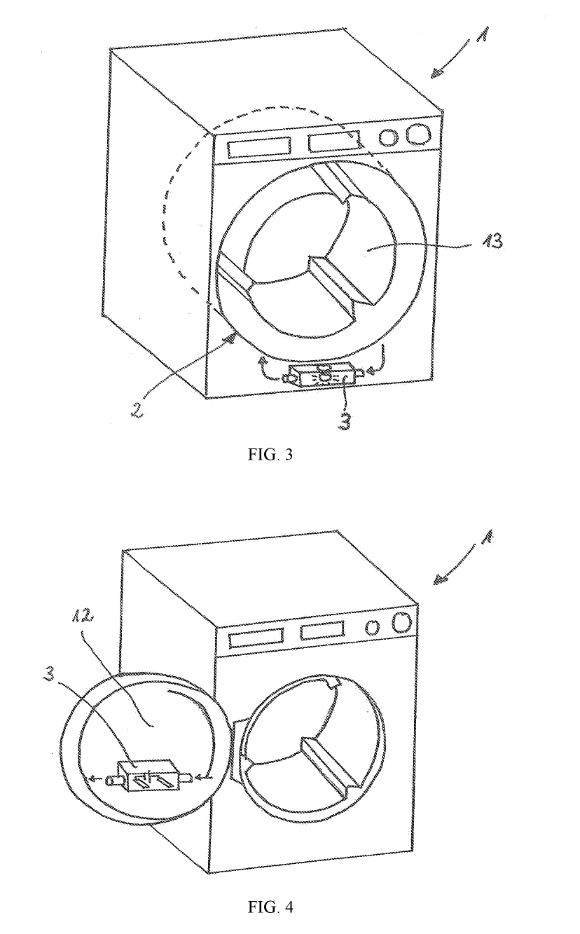

FIG. 3 is a schematic view of a washing machine comprising the decoloration reservoir from FIG. 1 according to the invention; and

FIG. 4 is a schematic view of a washing machine comprising the decoloration reservoir from FIG. 2 according to the invention.

The mode of operation of the decoloration reservoir is explained in greater detail on the basis of FIGS. 1 and 2.

FIG. 1 shows an embodiment of a decoloration reservoir according to the invention, which is denoted as whole by reference numeral 3 and is suitable for receiving washing fluid. For this purpose, the decoloration reservoir 3 comprises an inlet 4 and an outlet 5. Washing fluid (not shown) surrounding the decoloration reservoir 3 can enter the interior thereof through the inlet 4. The washing fluid can leave the decoloration reservoir 3 again through the outlet 5. The flow direction of the washing fluid is indicated schematically by arrows.

A UV radiation source 6 is arranged within the decoloration reservoir 3. The arrangement of the UV radiation source 6 within the decoloration reservoir 3 is merely shown schematically in FIG. 1, and in particular the electrical connections of the UV radiation source 6 have been omitted. The UV radiation source 6 may be a UV quartz lamp, which emits UV radiation at a wavelength of 254 nm.

If a washing fluid which contains a hydrogen peroxide (H₂O₂) and in which dyes are dissolved is conveyed into the decoloration reservoir 3 through the inlet 4, H₂O₂ molecules are activated by the UV radiation emitted by the quartz lamp, and highly-reactive, short-life hydroxyl radicals (OH) are produced. These OH radicals act on and decompose the dyes dissolved in the washing fluid. The washing fluid discolored in this way is lastly conveyed out of the decoloration reservoir 3 again through the outlet 5.

According to the invention, the term “discolored washing fluid” is intended to mean that the dye content of the washing fluid when leaving the decoloration reservoir 3 is considerably lower than when it enters the decoloration reservoir 3. The absolute degree of decoloration depends on various parameters, such as the original dye content in the washing fluid, the retention time of the washing fluid in the decoloration reservoir 3, the radiation intensity of the UV lamp, and other parameters.

FIG. 2 shows an alternative embodiment of the decoloration reservoir 3 according to the invention. Identical components are provided with identical reference numerals and are not explained separately in the following in order to avoid repetition. An electrode assembly 7, which consists of an anode 8 and a cathode 9, is positioned with the decoloration reservoir 3 shown in FIG. 2. The anode 8 is connected to the positive pole of an electrical DC voltage source 10, and the cathode 9 is connected to the negative pole. Here too, the electrode assembly is only shown schematically. The anode 8 may be a boron-doped doped diamond anode, and the cathode 9 may be a stainless-steel electrode. The DC voltage source 10 provides a voltage of 2.4 volts, for example.

If washing fluid containing dyes then enters the decoloration reservoir 3 through the inlet 4, then the water contained in the washing fluid is electrolytically split. In so doing, hydroxyl radicals are produced, which interact with and decompose the dyes contained in the washing fluid in the same way as already explained in relation to the embodiment shown in FIG. 1. The discolored washing fluid is lastly conveyed out of the decoloration reservoir 3 again through the outlet 5.

FIGS. 3 and 4 each show a washing machine comprising a decoloration reservoir according to the invention.

The washing machine 1 shown in simplified form in FIG. 3 comprises a drum 13, which is part of a washing chamber 2 and below which a decoloration reservoir 3 according to FIG. 1 containing a UV quartz lamp is arranged. The washing chamber 2 consists of the washing drum 13 and the space directly surrounding said drum, through which washing fluid flows during the washing cycle. The flow of fluid through the decoloration reservoir 3 is indicated by arrows. It is equally possible to arrange the decoloration reservoir 3 in a region below the drum 13 in the alternative embodiment using the electrode assembly 7. In the example shown, the decoloration reservoir 3 is an integral part of the washing machine 1.

Alternatively, the decoloration reservoir 3 may also be arranged in the region of a door 12 of the washing machine 1, as shown in FIG. 4. In FIG. 4, the decoloration reservoir 3 is mounted on the inside of the door 12 of the washing machine 1. The example shown contains the configuration in which the decoloration reservoir 3 comprises the electrode assembly 7. Of course, it is equally possible to mount the decoloration reservoir 3 comprising a UV radiation source 6 in the region of the door 12 of the washing machine 1. In this example, the decoloration reservoir 3 is installed in the washing machine 1 as a separate, battery-operated module, and can be removed if necessary.

The washing machine 1 according to the invention comprising a decoloration reservoir 3 and the method for washing textiles operated using said washing machine are therefore measures which can be used to minimize the risk of discoloration during the washing process in a washing machine. In particular, the invention is distinctive in that a wide range of dyes can be decomposed in a simple manner without the textiles themselves being negatively affected by the color-neutralization process. As a result of this reduced risk of discoloration, for the most part textiles do not need to be sorted into different colors before washing, and this represents a definite saving of time.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A washing machine (1) comprising a washing chamber (2) for receiving a washing fluid and textiles to be cleaned, and comprising a decoloration reservoir (3), which has an inlet (4) for conveying washing fluid out of the washing chamber (2) into the decoloration reservoir (3) and has an outlet (5) for conveying washing fluid out of the decoloration reservoir (3) into the washing chamber (2), which reservoir further comprises at least one activation module, which is suitable for initiating a process for forming free radicals in the washing fluid within the decoloration reservoir (3).

2. The washing machine (1) according to claim 1, wherein the activation module includes a UV radiation source (6).

3. The washing machine (1) according to claim 2, wherein the UV radiation source (6) is a quartz lamp or a UV LED.

4. The washing machine (1) according to claim 2, wherein the UV radiation source (6) emits UV radiation in a wavelength range of 100 to 400 nm.

5. The washing machine (1) according to claim 2, wherein the UV radiation source (6) emits UV radiation in a wavelength range of 250 to 400 nm.

6. The washing machine (1) according to claim 1, wherein the activation module comprises an electrode assembly (7), including an anode (8) and a cathode (9).

7. The washing machine (1) according to claim 6, wherein the anode (8) is a boron-doped diamond electrode.

8. The washing machine (1) according to claim 6, wherein the effective surface area of the anode (8) is 1 and 500 cm².

9. The washing machine (1) according to claim 6, wherein the effective surface area of the anode (8) is 2 and 100 cm².

10. The washing machine (1) according to claim 1, wherein the at least one pump is provided which pumps the washing fluid from the washing chamber (2) into the decoloration reservoir (3) and/or out of said reservoir.

11. The washing machine (1) according to claim 1, wherein the start and/or the intensity and/or the duration of the process for forming free radicals is controllable.

12. The washing machine (1) according to claim 11, wherein a temperature sensor is provided by which the temperature of the washing fluid is detected.

13. The washing machine (1) according to claim 1, wherein the decoloration reservoir (3) is permanently installed in a housing of the washing machine (1).

14. The washing machine (1) according to claim 1, wherein the decoloration reservoir (3) is designed as a separate, module.

15. The washing machine (1) according to claim 1, wherein the decloration reservoir (3) is battery-operated

16. A method for washing textiles in a washing machine using a washing machine according to claim 1, comprising the steps of:
placing the textiles to be washed into the washing chamber (2) of the washing machine (1);
starting a washing cycle;
conveying washing fluid from the washing chamber (2) into the decoloration reservoir (3);
initiating a process for forming free radicals in the washing fluid in the decoloration reservoir (3);
decomposing dyes contained in the washing fluid by means of the free radicals;
conveying treated washing fluid out of the decoloration reservoir (3) into the washing chamber (2).

17. The method according to claim 16, wherein the washing fluid is at a temperature of from 10 to 100° C.

18. The method according to claim 16, wherein the washing fluid is at a temperature of 20 to 60° C.
